(19) United States
(12) Patent Application Publication
(10) Pub. No.: US 2021/0135489 A1
(43) Pub. Date: May 6, 2021

(54) APPARATUSES, METHODS AND SYSTEMS FOR INTELLIGENT AND FLEXIBLE TRANSFER SWITCHES

(71) Applicant: SHYFT POWER SOLUTIONS, INC., Oakland, CA (US)

(72) Inventors: Cole Stites-Clayton, San Francisco, CA (US); Ugwem Eneyo, Houston, TX (US); Tyler Davis, Oakland, CA (US)

(21) Appl. No.: 17/150,575

(22) Filed: Jan. 15, 2021

Related U.S. Application Data
(63) Continuation of application No. PCT/US19/41804, filed on Jul. 15, 2019.
(60) Provisional application No. 62/698,197, filed on Jul. 15, 2018.

(51) Int. Cl. H02J 9/06; G06F 16/23; G05B 19/042; G01R 22/06; H02J 13/00; H02J 3/00

(52) U.S. Cl. CPC H02J 9/068; G06F 16/2379; G05B 19/042; G01R 22/06; H04L 67/10; H02J 13/00022; H02J 13/00002; H02J 3/0075; G05B 2219/25257; H02J 13/00004

(57) ABSTRACT

The present inventive concepts comprise a connected, intelligent transfer switch system that permits remote metering, monitoring and control of energy sources connected to a device both by hardwired and wireless connection, and the method for operating this system is disclosed. The inventive concepts represent a significant improvement upon existing transfer switch systems by incorporating advanced monitoring and control capabilities of all energy resources connected to a building, such as fossil-fuel powered generators, battery storage systems, solar photovoltaic arrays, wind turbines, utility grid connections, controllable loads, or other technologies which generate, store or consume energy. The inventive concepts further provide means for flexible and intelligent operation of these resources through a dedicated network communication connection which enables advanced operational decision-making to determine optimal switching actions and real-time interaction through user-facing digital interfaces.

### CROSS REFERENCE TO RELATED APPLICATION

This application is a continuation of International Patent Application No. PCT/US19/41804, filed Jul. 15, 2019, which claims the benefit of U.S. Provisional Patent Application No. 62/698,197, filed Jul. 15, 2018, which is incorporated by reference herein in its entirety.

### TECHNICAL FIELD

The present inventive concepts relate generally to the field of transfer switching equipment used for supplying power to a load output from a plurality of power source inputs.

### BACKGROUND

A transfer switch is an electrical switch used to supply power to a load output from a plurality of source inputs which could be any combination of a grid connection, one or more generator sources, or an alternative energy source such as a solar array or energy storage system. The traditional transfer switching technology falls broadly into two main categories, manual changeover switches and automatic transfer switches (ATS). Manual changeover switches employ a mechanical lever arm where an operator effects the transfer of electrical contacts from input source to another input source by throwing or changing position of the mechanical lever arm. ATS are switches that are automatic and trigger switching between different input sources when they sense one of the input sources has lost or gained power.

Manual changeover switches employ the mechanical lever arm to move electrical contacts from one input source to another. The lever is operated by a person at the particular moment when a transfer of power from one input source to another input source is desired. ATS units, on the other hand, do not require physical operations, and employ electrical logic to switch between the two input sources. Typically, in ATS devices there is a priority source, which is utilized as long as it is available; when this source experiences an outage, the ATS automatically switches power supply to the secondary source. This automatic switching to the secondary source is typically achieved through electromechanically operated contacts within relay or contactor units, though mechanically operated ATS systems also exist. ATS systems may have timing delays or protective systems, and these additional features may be adjustable via physical dials.

Modern ATS devices may alternatively utilize a microprocessor or microcontroller (MCU) to operate the system. These MCU controlled switch-based systems utilize digital logic to perform switching functions. Additionally, the MCU in the ATS can at times be configured to be programmed for certain additional features such as timing delay, protective thresholds, generator exerciser, or quiet hour scheduling. The most advanced state of the technology uses these MCU-controlled switch-based systems, which are digitally operated and may contain the above-mentioned functionalities, along with wired communication systems, which allow the ATS to interface with external systems, including gateways for remote monitoring, data logging, or integration within higher level building management systems. The types of protocols used in these advanced ATS systems may include RS-232 or RS-485 serial communication, Modbus networking protocols, or CAN bus systems, among others. Users of such systems include, for example, building or facility managers, technicians, or operators of large fleets of energy resources. The digital monitoring and control solutions are often highly technical and tailored towards commercial or industrial demand levels. The primary use case for these advanced systems is to provide detailed monitoring and system status information for critical power applications in which a transfer system must always be in good health to ensure availability of back-up power sources in the event of an outage of the primary source. This may be the case in hospitals, server facilities or other critical business operations.

However, even this modern technology includes limitations as current systems only perform switching actions based on a rigidly programmed set of rules and thresholds, or direct user intervention. These systems do not contain internal decision-making capabilities or the ability to utilize a more flexible or dynamic set of operating rules. For systems such as manually-operated mechanical systems, there is no information stored within the device and it contains no logic or algorithm for operating its switching mechanism as it can only be operated physically through human interventions. ATS technologies are also generally operated through a rigid set of rules, in this case the presence or absence of power, as well as in some cases certain other factors such as timing preferences, or scheduled periods in which the back-up source can or can not be utilized. None of these conventional technologies are capable of utilizing a dynamic set of information gathered from sources external to the device itself, for example information from other energy resources or from internet services, which could provide historical, real-time and predictive data on a variety of factors like grid availability, energy consumption, weather condition, user preferences and electricity pricing. The current conventional technologies do not allow flexible and remote changes to operational settings of the device. Manual changeover devices, as well as basic ATS devices, can only be operated in a single manner, according to their respective primary operating principles.

Advanced ATS units available may have the capability of switching between different operation modes, such as automatic or manual switching. The switching functionality, however, is not remotely configurable; rather settings must be set physically or programmed directly to the device and will persist until another programming update or physical change is made to adjust the rules of operation.

Consequently, there is a need for technological improvements that are directed to intelligent and flexible transfer switches that are configured to receive real-time updates on system status and are configured to make real-time changes to system status. In particular, there is a gap in the prior art for transfer switch systems which are specifically designed in the context of increasingly complex energy systems, which may both need to operate with more flexible control structures, taking into account a variety of external data and factors, and also need to serve use cases beyond critical power applications in which power switching is instead being utilized to achieve optimal cost, reliability, sustainability or a combination thereof. Current ATS systems are generally designed around the assumption that power should be supplied to the load as constantly as possible. While this assumption has generally been accepted in traditional use of transfer switching equipment, emerging use cases for switching technology point to a need to re-evaluate it. As described above, switching actions may be taken within a power supply system to improve optimal cost efficiency of the system as a whole, or to prioritize more sustainable power sources over more polluting sources. Further, switching operations may be taken as preventative measures for safety purposes, for instance in conditions where power on utility lines may increase risk of fire, or voltage transient activity may be expected on utility lines due to thunderstorm activity. With these new use cases in mind, and the expanding development of distributed energy systems further increasing the complexity of systems which exist behind the utility meter, there is a need for transfer switching equipment to address these new use case requirements.

Accordingly, the inventive concepts represent an improvement upon existing transfer switch systems by incorporating advanced monitoring and control capabilities of one or more energy resources connected to a building, such as fossil-fuel powered generators, battery storage systems, solar photovoltaic arrays, wind turbines, utility grid connections, controllable loads, or other technologies which generate, store or consume energy. The inventive concepts further provide means for flexible and intelligent operation of these resources through a dedicated internet communication connection and real-time interaction through user-facing digital interfaces. The result is a novel system that, while building upon the traditional mechanisms of transfer switch systems, defines a new role for the transfer switch as not simply a point of power switching in an electrical system but rather a central point of control and intelligence in that system more broadly.

### SUMMARY OF INVENTIVE CONCEPTS

The present inventive concepts overcome the drawbacks in the traditionally rigid operational logic by enabling flexibility and intelligent decision-making capabilities through a connectivity platform and a cloud software infrastructure that provides a remote interface for users to interact with the switching system. By including a dedicated and integrated connection to the internet, the inventive concepts ensure that operational logic is not constrained by information accessible only within the context of the single switch device. The interface may include a mobile or a web application, which a user may access in order to, for example, receive real-time updates on system status and make real-time changes to system status. The real-time changes to system status may include triggering the starting and running of generator, adjusting operational modes or parameters for future decision making, and/or viewing historical system events and data to understand past operations, among other functionalities.

The physical system according to non-limiting example embodiments disclosed herein may include up to three major hardware subsystems—a power switching sub-system, an energy metering sub-system, and a controls and communication sub-system. This physical system then may communicate securely to a cloud software system, which itself may include a number of individual web services, databases, and user applications.

According to non-limiting example embodiments disclosed herein, the physical switch system comprises at least one physical unit. This unit may comprise the power switching sub-system that is based around mechanically interlocked contactors, with electromechanical coils powered through relays that are driven by digital logic or specialized algorithm. The logic or specialized algorithm is directed through the control system, via execution of computer readable instructions, according to switching commands that are generated automatically, through user action within a digital interface, or through user activation of a pushbutton switch on the physical device. The digital interface may be accessed by the user through use of, for example, a smartphone, a tablet, a laptop, or any other handheld device capable of receiving and transmitting data. The power system may further include a means for manual fallback operation in which power from the incoming energy sources is used to directly engage contactor coils by means of a manually operated selector switch or arrangement of multiple switches that simultaneously disable the controls sub-system from acting upon the power switching mechanism while this manual mode is utilized. This manual fallback operation method is provided primarily for periods of maintenance or servicing of the switch unit itself or surrounding electrical components, for example when it would be unsafe to allow the switch to connect power automatically to a line which may be exposed to human contact.

According to non-limiting example embodiments, the device may comprise the energy metering sub-system, which may be configured to allow complete monitoring and metering of energy provided to the load outputs of the switch including current measurement and voltage measurement of a single alternating current power phase up to three active alternating current phases arranged in a wye configuration, each phase generating a voltage signal offset 120 degrees from the others in relationship to the neutral conductor. Additionally, the energy meter sub-systems may be configured with the capability of, including but not limited to, metering both forward and reverse energy flows, and power quality indicators such as power factor, voltage, frequency, and phase balance, among others. This energy metering sub-system may make use of current transformers, Rogowski coils, current shunts, hall-effect sensors or other current sensing technologies.

According to non-limiting example embodiments, the device may comprise the controls and communication sub-system, which incorporates one or more communication modules, such as a dedicated cellular module and a wireless local area network module in the example embodiment, for communication. This allows information to be exchanged with the internet/cloud directly as well as/or with other peripheral devices on a local network. These peripheral devices may include sensors and control devices that are responsible for providing the Intelligent Transfer Switch with additional data, such as the level of fuel in a tank, the status of alarm indicators on an energy asset such as a generator set or inverter, the state of charge of a battery bank, the rate of solar production from a solar array or a variety of other possible datasets. The communication and controls sub-system of the Intelligent Transfer Switch is responsible for managing the communication and networking with these devices in order to access the additional data and information they can provide. Information exchange through the network communication system to software cloud infrastructure allows integration of hardware and software layers to create a complete management platform.

According to non-limiting example embodiments, the device may be provided with a dedicated and integrated connection to a network, for example and without limitation, the internet. While some operational decision making can be carried out internal to the devices control system, the dedicated connection to a network allows this decision making framework to be extended to a connected internet platform, in which further operational logic and specialized algorithms can be utilized to add further intelligence to the transfer switching system. The present inventive concepts ensure that operational logic or specialized algorithm is not constrained by information accessible only within the context of the single device, but rather that it may draw upon external and flexible datasets to supplement and improve operational decision making. Examples of the use of this operational algorithm may include the comparison of set operational threshold values to real-time estimates of future parameter values as determined by predictive analytics. These analytics may draw upon historical data collected previously by the Intelligent Transfer Switch, or may utilize external datasets. User commands/settings/preferences may be accessed and updated remotely as well through this dedicated and integrated connection to the network. Furthermore, the information may be assessed to determine optimal operational strategies at any given moment. These optimal strategies may be, in some implementations, based around parameter thresholds determined by system modeling, which inform decision making by the Intelligent Transfer Switch as system events occur and are processed by the cloud software systems. Parameter thresholds may include, for example and without limitation, maximum depth of discharge battery banks, minimum loading level for generator units, or optimal battery usage for solar self-consumption optimization. In order to realize the benefits of real-time remote access to the switching device, the full embodiment of the inventive concepts may further include cloud software infrastructure to provide a remote interface for users to interact with the switching system. By incorporating both a real-time remote interface for users as well as a system for automatic operation based on sets of operational rules, the system is able to simultaneously operate itself based upon the strategies that the system's modeling has deemed optimal for maximizing or minimizing certain desired parameters, such as cost or energy reliability, while also remaining responsive to user desires and allowing them to override this operational strategy if their preferences dictate that a change to the energy system is necessary at any given moment.

According to non-limiting example embodiments, the interface may be a mobile or web application, which a user may access in order to, for example, including but not limited to, receive real-time updates on system status, make real-time changes to system status, such as triggering the starting and running of a generator, adjust operational modes or parameters for future decision making, or view historical system events and data to understand past operations, among other functionalities. The internet connectivity may also ensure that the device is not bound to a particular set of operational rules. This set of rules may be updated on an ongoing basis either automatically or by user interactions in order to more flexibly operate the system. The increased flexibility in operating the system may ensure that the device does not operate purely in manual or the automatic modes but is capable of working as either type of traditional transfer switching technology and dynamically varying its operating mode in accordance with what is preferred for optimal operation during any given period.

According to non-limiting example embodiments, the device may be embedded with the ability to communicate with the peripheral energy resources, or other Intelligent Transfer Switch systems, through a local wireless or wired communication method. This capability may allow the device to incorporate the status and availability of other energy sources or systems into the decision-making framework for transfer switching operations, and may further allow the device to act as a controller of these other energy resources to help perform system operations beyond solely transferring of power between the two input sources. These further operations include but are not limited to enabling or disabling battery charging, curtailment of solar production to comply with grid restrictions, transacting of energy with other energy systems, or setting inverter mode state to allow for load sharing between a generator and battery storage back-up. In some embodiments, these mode settings may be either maintained statically on a device such as an inverter, or else programmed by hand at set-up with operational thresholds intended for use over the system's lifetime. The ability for the cloud connected system to perform changes to these settings in a dynamic fashion allows insights gathered from data generated by the system to inform system operation in real-time.

These and other aspects of non-limiting example embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the non-limiting example embodiments herein without departing from the spirit thereof, and the non-limiting example embodiments herein include all such modifications. It is to be expressly understood, however, that the drawings are for the purpose of illustration and description only and are not intended as a definition of the limits of the disclosure. As used in the specification and in the claims, the singular form of “a”, “an”, and “the” include plural references unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 illustrates an electrical system diagram showing the Intelligent Transfer Switch with main electrical inputs and outputs according to an example embodiment;

FIG. 2 illustrates an exemplary architecture for the Intelligent Transfer Switch at a high-level, indicating the various major sub-systems;

FIG. 3 illustrates the Intelligent Transfer Switch internal architecture/subsystems according to an example embodiment;

FIG. 4 illustrates the Intelligent Transfer Switch internal architecture/subsystems according to a further example embodiment;

FIG. 5 illustrates Intelligent Transfer Switch communication interfaces including cloud software system components according to an example embodiment;

FIG. 6 is a block diagram illustrating the process by which data is collected from the intelligent Transfer Switch and stored within a database in an example embodiment;

FIG. 7 is a block diagram illustrating the process by which a real-time request for data or control command may be sent and confirmed from a user application to the Intelligent Transfer Switch in an example embodiment;

FIG. 8 is a process flow diagram of decision-making logic, involving information from the cloud and local information according to an example embodiment; and

FIG. 9 is a block diagram illustrating the process by which a system event originating from the Intelligent Transfer Switch system may initiate the system's decision-making logic and cause an automatic operational action to be taken based on this logic in an example embodiment.

### DETAILED DESCRIPTION OF INVENTIVE CONCEPTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

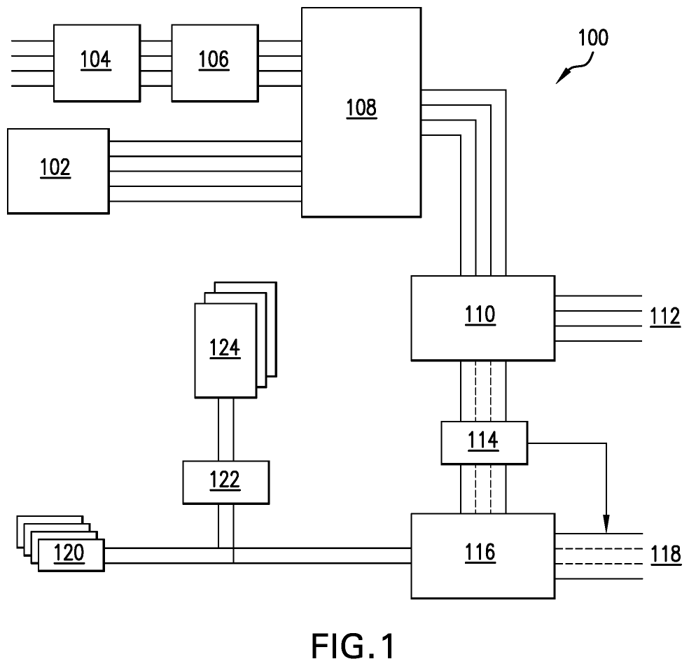

FIG. 1 describes an example electrical system 100 diagram showing flexible and intelligent transfer switch or hereinafter referred to as “Intelligent Transfer Switch” 108 with main electrical inputs and outputs according to an exemplary embodiment. The flexible and intelligent transfer switch obtains input power from two or more sources. In FIG. 1 this is shown as a generator 102 and a utility service entrance, which has been protected with a set of fuses 104. Other sources of input power which could replace either the utility service entrance, generator or both include, without limitation, power from an inverter, having sourced and inverted DC power into AC power from any combination of solar arrays, wind turbines or battery energy storage systems, a fuel cell, a reactor or another source of power. The generator 102 can receive a generator remote start switch signal from the Intelligent Transfer Switch 108 and the utility service entrance fuses 104 provide the power supply through a utility meter 106 as long as meter credit is sufficient and the grid is not experiencing an outage. Credit in this context refers to a stored balance of energy units which has been pre-paid for by the utility customer and loaded onto the utility meter device 106. When these credits are fully utilized the utility meter will block further power from being supplied. According to the availability of input power sources and accounting for any operational rules or modes which have been enabled, Intelligent Transfer Switch 108 then utilizes its internal transfer switching mechanism to connect the power from the utility or the generator through to a main breaker panel or distribution board 110 or to not connect any power supply. The internal transfer switching mechanism may correspond to a transfer initiated based on electrical connections. The main breaker panel or distribution board 110 provides power to the various distributed loads of the building 112. In FIG. 1 the system then forms a sub-circuit, which may be powered with a single or three phase power supply, and which is supplied through an inverter bypass switch 114. The inverter bypass switch 114 controls the power supply to the inverter system 116, which further controls the power supply to a set of small or critical loads in the building which should be supplied with power at all times 118. The inverter 116 controls power supply to the critical loads 118 by optionally passing power through from the main breaker panel 110 or supplying inverted power from a plurality of solar arrays 124 through a charge controller 122 and a plurality of battery banks 120.

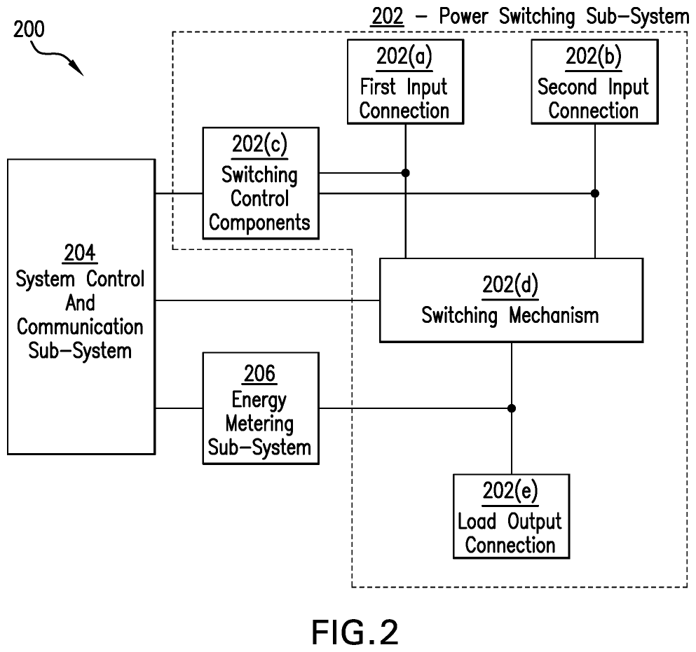

FIG. 2 shows an exemplary architecture for the Intelligent Transfer Switch system 200, identifying the major sub-systems which may be included in an embodiment of this invention. The architecture of the typical embodiment will comprise three main sub-systems. The power switching sub-system 202 has as its mains functionalities, the connection of the system to two distinct input power sources 202(a), 202(b) as well as the connection to a single load output 202(e), and the mutually exclusive switching 202(d) of those two input power sources onto the load output such that one or the other power source supplies power to the load, or no power source may be supplying power if none is connected. This switching capability may be achieved, for example, with a mechanically interlocked pair of assembled contactors, electrically interlocked relays, motorized circuit breakers or other switching mechanism 202(d) suitable rated for the full load current of the given application. A further characteristic of the power switching sub-system 202 is the inclusion of certain components 202(c) which act to provide protection and control of the power lines which form the control signals that act upon the main switching mechanism to actuate the switching process. In the exemplary embodiments described herein, the signals which control the power switching mechanism are single phase power lines derived from the two incoming supply sources, at full line voltage. The protective and control components 202(c) will be varied according to the specific embodiment of the invention and at the discretion of the designer with respect to the desired specific conditions of operation, but may include components such as fuses to provide over current protection, surge protection devices to limit the impact of over voltage transient events, time delay relays for enforcing specific timing of switching actions, or voltage monitoring and protection relays which may act to block a control signal if the voltage conditions do not meet certain criteria, such as being greater than 70% of the nominal line voltage, for example and without limitation. The protection and control components 202(c) may also comprise the selector switch or switches which may be used to enable a manual fallback operation mode, in which the power switching mechanism 202(d) can be operated separately from the control and communications sub-system 204.

The control and communications sub-system 204 connects to the power switching sub-system 202 both by way of inputs, including sensing and detecting circuits which indicate the state of the power switching sub-system, and outputs, including control of the power switching lines described above which are used to actuate the power switching mechanism. This sub-system 204 comprises all network communications capabilities, whether on a wide-area or local area network, and further comprises all user indication and interface functionality. This sub-system 204 contains the microcontroller or other processor unit which runs the Intelligent Transfer Switch unit 200, and contains data storage and memory for both the programmed instructions for operation of the device and stored data points which have been collected through its operation. The control and communications sub-system 204 further connects to the energy metering subsystem 206 via an isolated communication interface such as an SPI, I2C or Serial bus. The energy meter subsystem 206, consisting of dedicated circuitry allowing for sensing of metering parameters such as voltage, current, real-time power and power quality factors, connects to the load output portion 202(e) of the power switching subsystem 202 in order to collect the specified parameters to communicate them back to the control and communication sub-system 204 via the bus previously described.

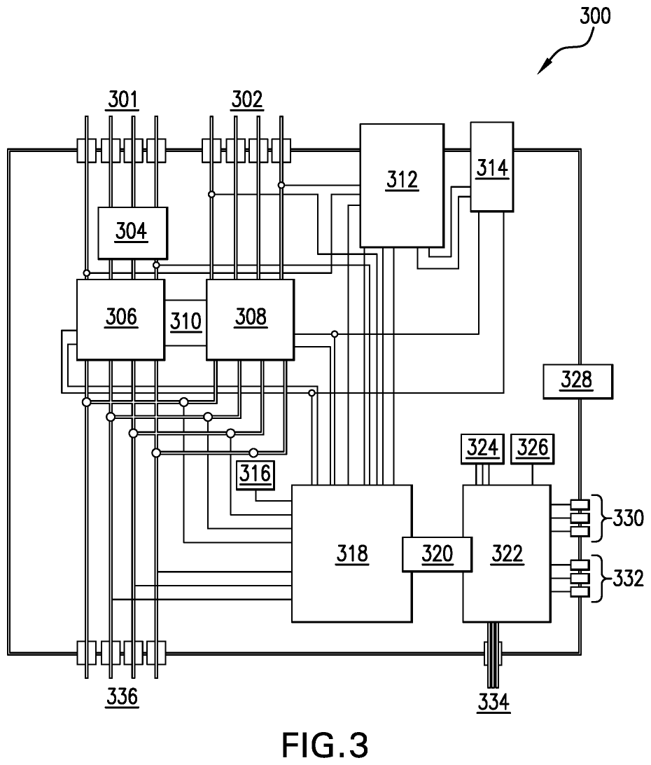

FIG. 3 describes the internal architecture/subsystem of Intelligent Transfer Switch 108 according to an exemplary embodiment 300. The input is provided by two supply sources, namely a grid supply 301 and a generator supply 302. In an embodiment, the grid supply may provide power through a fuse block 304 comprising three or more 125 ampere rated fuses of, for example, NH type. One skilled in the art would appreciate that NH type of fuses are rated for interrupting main circuit loads. Accordingly, these fuse types may be replaced by other types of fuses or a circuit breaker provided that the replacement protection device is of a similar rating and specification. The overcurrent protection may also be omitted from the wiring in embodiments in which it has been determined that proper overcurrent protection is provided externally to the Intelligent Transfer Switch. Returning to the current exemplary embodiment, the fuse block and the generator supply respectively provide power to a grid contactor 306 and a generator contactor 308, which are mechanically interlocked together to prevent interconnection of the two power sources. The device further comprises one or more selector switches to enable a manual fallback mode. The two switches may be a DPDT (double-pole double-throw) switch 312 and a DPST (double-pole single-throw) switch 314 as in this embodiment, or may also be replaced by a single rotary switch utilizing multiple contacts to achieve a similar configuration, the purpose of the configuration being to direct the control line either toward the main control electronics system or alternatively to the manual mode when such fallback mechanism is required. It would appreciated by one skilled in the art that many possible switch configurations may be created to achieve the same desired result. One or more fuses or circuit breakers of up to 5 amperes are further connected to the output of the contactor assembly 306+308 for over-current protection of power supply to a high voltage/isolation board 318. In this exemplary embodiment, one fuse with a rating of 5 amperes is used 316. The high voltage/isolation board 318 comprises input terminals including grid and generator detection inputs which utilize an optocoupler technology to detect the presence of power on the AC line input for each source, inputs for voltage sensing and inputs for current sensing through current transformers, for example. The high voltage/isolation board also comprises outputs driven by, for example, electromechanical relays; these outputs provide control signals to the grid and generator contactors 306+308 such that the control system is capable of operating the contactor assembly to perform switching actions. The high voltage/isolation board 318 is connected to the low voltage/control board 322 through a ribbon cable or other connecting component 320. The low voltage/control board 322 is provided with connectivity to a network through a cellular antenna 326 and back-up power is supplied by a LiPo (Lithium polymer) battery 324. The low voltage/control board may be provided with a plurality of LED's 330 as a means of indication to the user of the status of the Intelligent Transfer Switch, and a plurality of push buttons 332 to provide a physical interface for controlling switching functionality. It would be appreciated by one skilled in the art that the means of providing both indication and a physical interface may be distinct in various embodiments of the invention, incorporating other appropriate technologies including, for example and without limitation, an LCD or LED display screen, an audio indicator, toggle buttons, capacitive touch sensors or a touch screen interface. The low voltage/control board further comprises the generator remote start connection 334. The generator remote start connection may use a “two-wire” start interface in which two wires are connected across a relay output which may be located within the control system on the low voltage board 322. When the relay is energized, the two wires are electrically connected, activating a digital input on the generator set which triggers the generator set to begin running. When the relay is de-energized, the two wires become electrically isolated, and the generator set ceases to run. Output to the load 336 may be provided by connections to the output of both the grid and generator contactors, the outputs of each contactor being joined on the load side such that either input source may power the load equally depending on the position of the contactor switching mechanism.

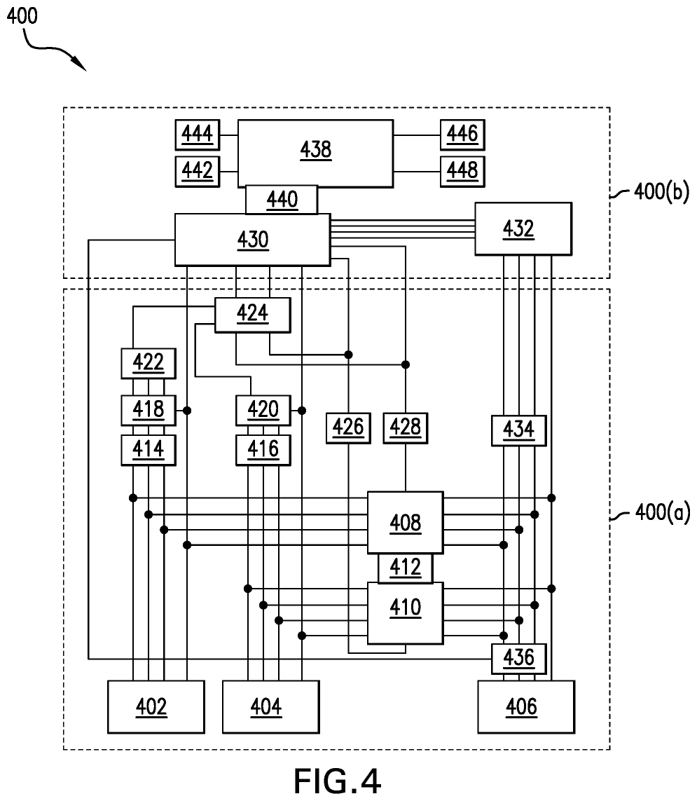

FIG. 4. describes the internal architecture and major components of the Intelligent Transfer Switch 400 according to a further exemplary embodiment. In this embodiment, the apparatus is at the highest level divided between two compartments, a switching compartment 400(a), which houses the components mainly associated with the power switching functionality and protective mechanisms, and is where the main input and output terminals are provided, and the control compartment 400(b), which houses the electronic systems, corresponding to the functions of control, communication, and energy metering as well as some further protective mechanisms. The two compartments together form an embodiment of the Intelligent Transfer Switch 400 which, while differing from the previous embodiment in some ways, embodies the same core elements of the inventive concepts described herein.

The switching compartment 400(a) of this exemplary embodiment comprises a plurality of input terminals 402, 404, corresponding to the wiring needed to connected all three phases, plus neutral and protective earth conductors from the three phase wye configured power supply originating from two power sources, in this case the utility grid connection and a diesel generator set. The grid input terminals 402 and generator input terminals 404 are connected to a grid contactor 408 and a generator contactor 410, respectively. The two contactors 408,410 are interlocked together with a mechanical interlock mechanism 412, forming a contactor assembly which is the core power switching mechanism underlying the power switching sub-system. The outputs of the contactors in the contactor assembly 408,410,412 are joined together such that either input source may provide power to the same set of loads. This output wiring is further connected to the load output terminals 406, where the electrical wiring connections are present to enable the connection of the building's load wiring with a three-phase wye configured power supply arrangement.

The grid and generator input lines 402,404, while connecting to their respective contactor units 408,410, may also each form a connection with a set of fuse links 414,416, one fuse being used to protect each of the three active phases of the three-phase wye configured power supply. These fuse links 414,416 may form a mechanism for over current protection between the main power conducting lines and the control system which will monitor and operate the main power switching mechanism. In this embodiment, the fuse links 414,416 may consist of 4A class CC fuse links installed within DIN rail mounted fuse holders, but it will be appreciated that many similar fuse link configurations, or other components such as miniature circuit breakers, may also be used to achieve a similar function without departing from the spirit of the inventive concept. The power connections from the output of the fuse links 414,416 may be further connected to a set of LED indicator lamps 418,420, in this embodiment set up such that one LED lamp gives an indication of the presence of power on each individual phase of the three phase power supply from both the grid and generator input sources, resulting in a total of six LED indicators in all. In the case of the grid supply, the control lines may be further connected to a voltage monitoring relay component 422, which acts to disable the use of the grid power supply in conditions of low voltage or phase loss. This component forms part of the sub-system which protects the user from connecting to a power source that is undesirable due to poor quality of the supply. It will be appreciated by one skilled in the art that this relay may be set to varying thresholds, for example with a minimum voltage cutoff of 70%, 90% or other portions of the nominal line voltage, in accordance with the preference of the user as well as the sensitivity of the loads which may be connected downstream of the Intelligent Transfer Switch system 400.

Following the connections of the three phase supply to the voltage monitoring relay 422 and LEDs 420 from the grid supply input and generator supply input respectively, a single phase may be further connected within the system to a single rotary cam selector switch 424. This switch may function to enable a manual fall back mode, as a alternate embodiment to the selector switches 312,314 referenced in the previous exemplary embodiment, and may comprise connections between the single phases from the grid and generator inputs which may be either further connected, in one setting of the switch, simultaneously to the High Voltage/isolation board component 430 within the control compartment 400(b), or, in a second setting of the switch, the grid input alone may be connected to a an output which, after passing through a time-delay relay 428, may connect to the grid contactor 408 control terminal and activate it to switch to the grid source. Similarly, a third setting of the switch may connect only the generator phase input to an output which, after passing through a time-delay relay 426, may activate the generator contactor 410 to supply power from the generator source. The time-delay relays 426,428, in this embodiment, may be used to control the timing of switching operations, ensuring some period of intervening time is enforced between the use of one power source and the use of the second power source. In a final setting of the selector switch 424 the control signals may be disconnected from all outputs of the switch, effectively placing the Intelligent Transfer Switch 400 into an off or standby mode in which no power source will be utilized.

The control phases, being connected to the high voltage/isolation board 430 based on the setting of the rotary cam selector switch 424, are used as detection mechanisms to determine the presence of power on the two power source inputs 402,404. The high voltage/isolation board 430, in this embodiment as in the previously described embodiment, may comprise these inputs for AC line detection, and may further comprise outputs driven, for example, by electromechanical or solid-state relays. These outputs may then connect back to the control lines within the switching compartment 400(a) which, through their connections to the time-delay relays 426,428, act upon the contactor assembly 408,410 to perform switching actions. These outputs may form the basis upon which the control system, through operation of the relay components which drive the outputs, is able to enact control actions for power switching within the Intelligent Transfer Switch 400. The high voltage/isolation board 430 may further comprise a series of input connections from surge protection board 432, which may itself make connections to the three phase power supply lines which form the load output circuit 406 within the power switching compartment 400(a). These lines may be protected from over-current or short circuit events by the connection of in-line fuse links or circuit breakers 434 between the load terminals 406 and the surge protection board 432. The surge protection board 432, placed between the high voltage/isolation board 430 and the over current protection devices 434, may act to limit the peak voltage experienced on these power lines during a high voltage transient or surge event. The high voltage/isolation board 430, utilizing these connections from the surge protection board 432 as well as further connections to a set of current sensing devices 436, for example current transformers, situated so as to capture the current being output to the building loads on each of the three phases of the power supply output, comprises components to enable energy metering of the load output as well as components to derive internal low voltage power supply rails which are used to power the electronics residing on the high voltage/isolation board 430, the low voltage/control board 438, the surge protection board 432 and the display board 446.

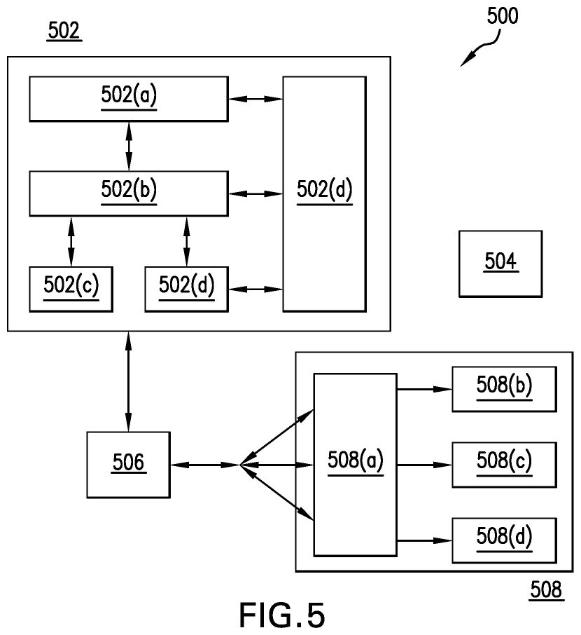

The low voltage/control board 438 is connected to the high voltage/isolation board 430, in this embodiment, by means of a stackable pin header 440, but may be connected by any means of wire to board or board to board connector solutions which allow the interconnection of power and signal lines between two circuit board. The low voltage/control board 438 may comprise components such as i) the main microcontroller unit, which acts as the main processors for the Intelligent Transfer Switch 400, ii) the cellular modem which, in conjunction with the attached cellular antenna 442, allows for connection to a cellular network for transfer of information to the internet or other networks, iii) memory storage components such as flash memory for non-volatile storage of data or computer readable instructions for operation of the Intelligent Transfer Switch 400, iv) further networking components such as second wireless radio for local wireless network communication or transceivers for wired communication protocols such as RS-485 or Modbus, either or both of which may be used for communication to peripheral monitoring devices as further described in FIG. 5, v) battery charging and state of charge tracking components, which relate to the further connection of a battery pack 444 to provide power to the electronics system when neither the grid nor generator power sources are connected within the Intelligent Transfer Switch 400, or finally vi) a relay which upon activation sends a remote start signal to the connected generator such that it will begin running and providing power to the generator input terminals 404. The low voltage/control board 438 further comprises connections to user interface elements. In this embodiment, indication of system state may be provided through the connected display board 446, which may comprise an LCD character display with a backlight functionality. User inputs may be collected through the connection of four connected pushbutton switches 448, corresponding generally to three buttons for the indication of desired power source between grid, generator or none, and a final button for operation of the LCD display 446 which may act to enable or disable the backlight as well as cycle through displays of various parameters of the operating state of the Intelligent Transfer Switch 400.

Next, referring to FIG. 5, a diagram of the Intelligent Transfer Switch communication interface 500 including cloud components is illustrated according to an example embodiment. The interfacing diagram comprises a cloud software block 502 having a block for data analysis, modeling, machine learning and predictive analytics 502(a) and having a two-way connection with a block for data storage 502(b) which is further connected to two blocks of internal data pipeline 502(c) and real-time event services 502(d). The data storage 502(b) may correspond to memory, which may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Data storage or memory 502(b) for storing data may include a self-referential table that may have additional rows and columns as machine learning and predictive analytics 502(a) executes a specialized algorithm. The internal data pipeline 502(c) handles all incoming data from the Intelligent Transfer Switch 506 and any peripheral devices 508(a), performing any required transformations or sorting of this data and storing it within one or more databases 502(b) that have provisioned for such data storage. The real-time event service 502(d) occupies a similar role within the software cloud infrastructure. This system is responsible for handling all incoming real-time system events from the Intelligent Transfer Switch 506, organizing these events, broadcasting them to a variety of microservices in addition to the main API 502(e). This broadcasting may be achieved through a series of messaging queues in which real-time events are enqueued into message exchanges with certain tags and parameters so that the appropriate software services will receive the messages.

The main cloud software components, encompassing learning and data analytics 502(a), data storage 502(b), real-time event processing 502(d) and internal data pipeline 502(c) are connected to an API (application user interface) 502(e) which connects with the user application 504 for the remote interaction with the Intelligent Transfer Switch device and the data which it has collected. The user application 504 may be accessed through, for example and without limitation, a hand-held device or a laptop computer, and may include an interactive graphical user interface (GUI), which a user may interact with in order to provide input and retrieve information therefrom. These inputs and outputs of information within the user application may initiate actions to be taken upon the Intelligent Transfer Switch device, for example in the case that the user has changed an operational mode setting or requested an immediate change of power source. It may also allow simply for the viewing of current system status or real-time power parameters such as the current operating power source or the power consumption from the load at that time. The cloud software block is connected to an intelligent switch device 506 through a WAN (Wide area network) connection and is further connected to a local nanogrid block 508 through a LAN (Local area network) connection. This connection may be made via wired or wireless communication solution, including Modbus network wired communication, Zigbee or LoRa wireless network formation, direct Bluetooth or other 2.4 GHz wireless protocols or other specialized networking protocol. The local nanogrid block 508 comprises a plurality of communication nodes 508(a) for the monitoring and control of assets within the energy system, for example, a diesel generator 508(b), a hybrid inverter system 508(c) or other energy resources/monitors/smart loads 508(d). The communication nodes 508(a) connected in this system may include any device configured to provide data or control capabilities to the Intelligent Transfer Switch system, for example and without limitation, a device sensing production of a solar array, output of an inverter system, level in a fuel tank or alarm status of an energy asset such as a generator set.

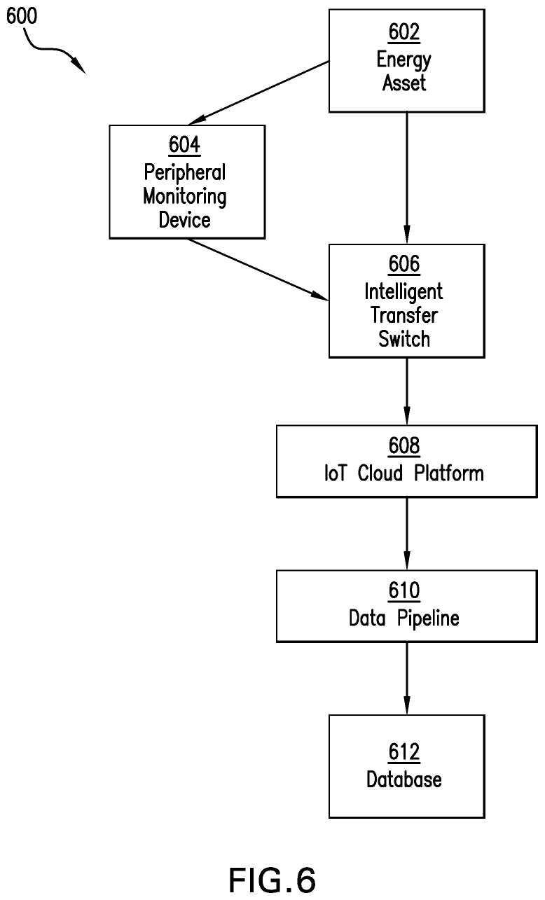

FIG. 6 describes the process 600 by which data is collected by the Intelligent Transfer Switch 606 to be stored in a database hosted with the cloud software architecture. Data originates from an energy asset 602, based on the measurement of some condition or parameter. The energy asset 602 may be a device which produces energy, such as a generator, solar array, or grid connection, a device which stores energy, such as a battery bank, or a compressed air storage device, a device which consumes energy, such as an air conditioner, water heater, water pump or lighting fixture, or a device which transmits or converts energy such as a distribution panel, an inverter, or a wire conductor. An energy asset 602 may further be understood to be any device or condition which may produce data relevant to the operation of the Intelligent Transfer Switch 606. This may include, for example and without limitation, devices which monitor weather conditions, air temperature or building occupancy. The data created through the monitoring of parameters or conditions of this energy asset 602 may be collected either directly by the Intelligent Transfer Switch 606, or by a peripheral monitoring device 604, configured as described previously to share a local network connection to the Intelligent Transfer Switch 606 in order to transmit the collected data to the Intelligent Transfer Switch 606 after collection from the energy asset 602. The Intelligent Transfer Switch 606, utilizing the integrated and dedicated network connectivity described herein, will transmit this data to the software cloud system herein described by first publishing the data to an IoT cloud platform 608, which functions to manage direct device-to-cloud interactions. The data may be transmitted via, for example, a publish-subscribe mechanism, in which the IoT cloud platform 608 has subscribed to received published data packets originating from the Intelligent Transfer Switch 606. The data, having been received by the IoT cloud platform 608, is further transmitted to a data pipeline service 610 via, for example, a web hook message. The data pipeline service 610 may be responsible for actions such as parsing, cleaning, aggregating or otherwise manipulating incoming data in order to structure it correctly for storage. Following data manipulation, the data pipeline 610 may write the incoming data to one or more databases 612 for storage. These databases 612 may include, for example, relational databases or time-series databases. The data pipeline 610 will be responsible for structuring the query such that data is written correctly to the appropriate database 612, completing the data storage process.

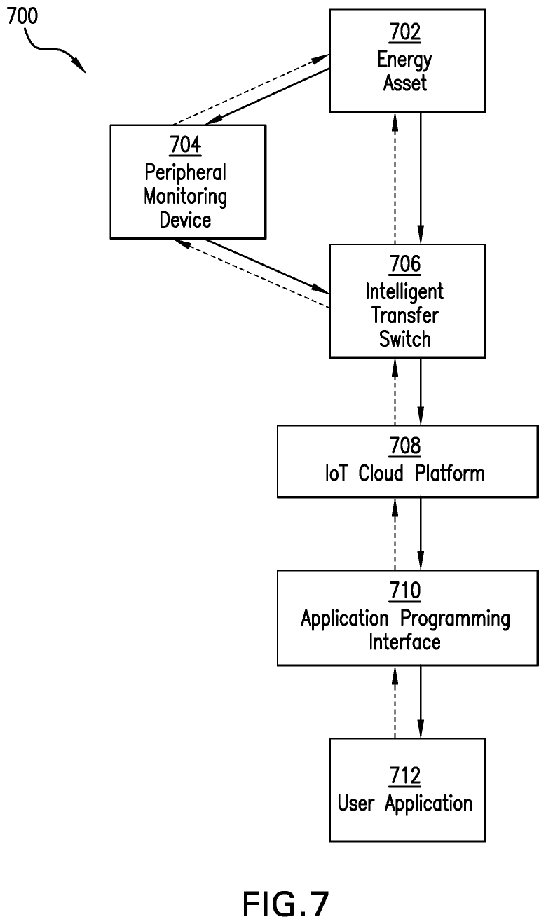

FIG. 7 illustrates a typical process 700 by which real-time data, corresponding to, for example, system status or current power consumption values, may be requested and received by the user from a user application 712. Initiating the described process 700, a user may request a real-time parameter from within an application 712, for example via mobile phone or web interface. This requested information may correspond to power consumption values such as the real-time power being utilized, which source is currently supplying power, how much solar power is being produced, or what the current state of charge of a battery bank is, among other possible values. This request, being registered in the user application 712, is first transmitted to the application programming interface (API) 710 a web-service which manages flow of data and information between user applications 712 and other software services, and may handle, among other tasks, the management of user sign in sessions and password information via encrypted keys. After receiving the request from the user application 712, the API 710 will further transmit that request to the IoT cloud platform 708, which, as described previously, has as its primary capability the direct transfer of information between the cloud software system and the Intelligent Transfer Switch device 706. The IoT cloud platform 708 may request the information once, or multiple times in the event of an initial failed request, for up to some time to live period at which point, if a request is unsuccessful, it may time out. Upon a successful request of information to the Intelligent Transfer Switch 706, the Intelligent Transfer Switch 706 may respond immediately with the requested information if it is available within the memory stored directly within the device, or it may take a measurement or reading of a sensor or system state in order to supply the most up to date information on the requested parameter. The Intelligent Transfer Switch 706 may also further transmit the request for data to a peripheral monitoring device 704 if that device is the one capable of collecting the information which has been requested initially by the user, for example by taking a measurement of a connected energy asset 702. Regardless of the collection mechanism, once the information that was requested has been gathered or identified by the Intelligent Transfer Switch 706, the data will be returned to the cloud via transmission from the Intelligent Transfer Switch 706 to the IoT cloud platform 708 by similar mechanism as described previously. The requested data will return from the IoT cloud platform 708 to the API 710 by way of a web hook or similar data transmission mechanism. The API 710, finally, will supply the requested data back to the user application 712 for display on the user interface. This entire roundtrip process may take only milliseconds to complete, or up to a number of seconds in the event that data must be measured or collected from peripheral devices 704. Requests of this nature may also originate from user applications 712 on a periodic basis while a particular interface is loaded, in order to asynchronously maintain the most up to date information possible within the user interface.

Returning to FIG. 5, The machine learning and predictive analytics 502(a) corresponds to a specialized algorithm executed by a processor. Upon execution of computer readable instructions stored in a memory, the processor is configured to determine optimal operational actions based on both historical and real-time data collected from the intelligent transfer switch device, as well other external datasets such as weather forecast data. As historical data is collected for a given system, based on factors such as energy consumption, utility grid availability, and solar energy production, among many other possible factors, the processor builds a model of the energy system. This modeled energy system includes the main energy assets utilized in the system and the parameters and values corresponding to these assets. For example, given a system utilizing a generator set, a solar photovoltaic array, a battery storage bank and a hybrid inverter system, the model will include the presence of these assets, the electrical connections formed between these assets, and the relevant ratings of each. In this example, those ratings may include, without limitation, the peak power rating of the generator and size of its fuel tank, the peak power rating of the solar array, the voltage and capacity of the battery storage bank, the maximum charge rate and peak power output of the hybrid inverter.

In an example embodiment, the processor will test operational rules and strategies for running the system against historical data, and identifying the optimal thresholds for utilizing resources such as the battery bank and generator unit. This testing of rules will be carried out on the modeled components and their parameters. For example a generator may have a minimum loading under which the efficiency of the engine is significantly reduced, and a maximum loading over which it can not operate. Similarly, an inverter may have a maximum power output and a battery may have a maximum depth of discharge associated with its chemistry. These parameters may be set directly as operational thresholds, or also may be tested across a spectrum to determine the optimal operational threshold. For example, a system may be modeled against a set of representative data in order to determine the best charge and discharge thresholds for a battery bank in order to maximize solar self-consumption, or an adjusted maximum depth of discharge may be set if it is determined that maintaining higher battery capacity would increase overall lifespan of the battery and achieve the best system lifetime cost savings when tested against the representative dataset. In real-time, as system events occur, the processor may compare the incoming system events and state values to these operational thresholds, and make determinations about the use of resources for optimal cost efficiency or some other factor for the system. The processor can, at any point, be overridden by direct user intervention when a particular operating mode is desired by the user. As further data is collected over time, this further data may be included in the historical record for the system, and the model optimization process may be performed at intervals to update operational thresholds in the case of changes in usage patterns, grid performance, or other external conditions.

As used herein, processor, specialized processor, specialized microprocessor, and/or digital processor may include any type of digital processing device such as, without limitation, digital signal processors (“DSPs”), reduced instruction set computers (“RISC”), general-purpose (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, specialized processors (e.g., neuromorphic processors), and application-specific integrated circuits (“ASICs”). Such digital processors may be contained on a single unitary integrated circuit die, or distributed across multiple components.

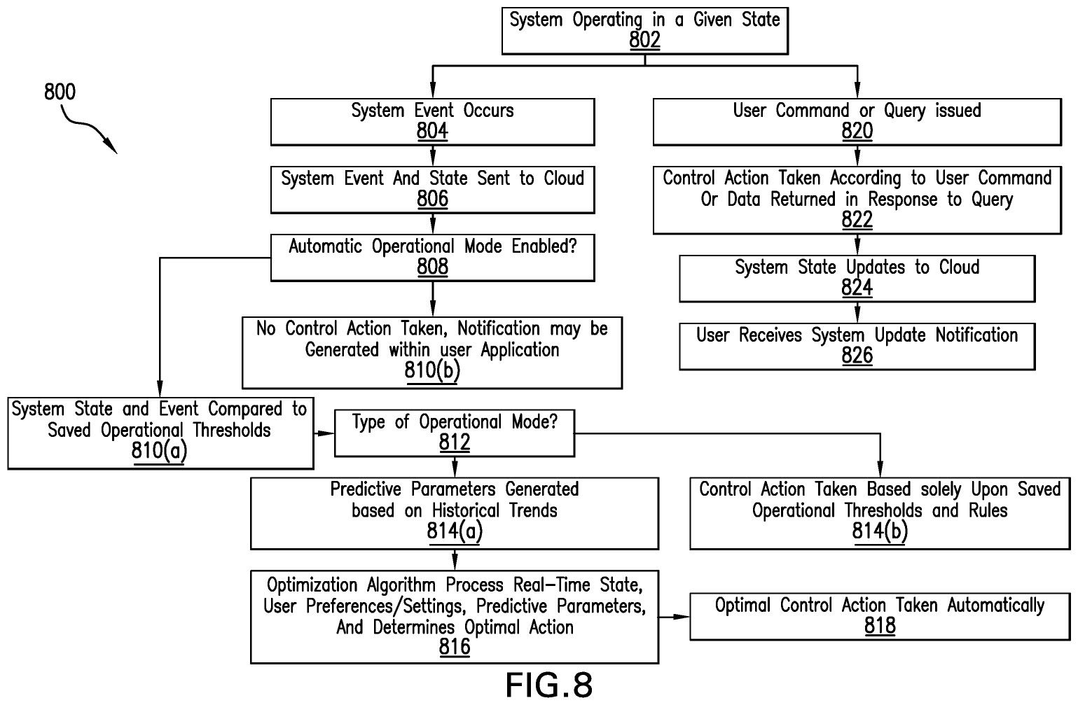

FIG. 8 illustrates a flowchart 800 of general decision making logic, using information from the cloud and local information according to an example embodiment. The system operates in a given state at step 802 wherein when a system event occurs at step 804 the system event and state is sent to a cloud software system as described in FIG. 5 at step 806. The state of the flexible and intelligent transfer switching system relates to the source of power supply and load configuration. State may be assessed through the combination of one or more sources such as utility grid, generator, solar photovoltaic panels, or battery banks supplying energy to one or more loads such as main panel loads, critical loads, or the exporting of power to the utility grid. System events relate to a change in the characteristics of the system, which can potentially alter the system state. For example, system events may include the grid becoming available, or unavailable, a battery bank reaching a pre-set level of discharge, or a solar array beginning to output above a certain power threshold. The cloud system checks whether the automatic operational mode is enabled at step 808 and compares the system state and event with saved operational thresholds in its memory at step 810(a) if so. If no automatic mode of operation is enabled, but rather the system is currently operating in manual mode, the system will take no automatic control action, but will finally generate a notification to the user application at step 810(b). Prior to the comparison with the saved operational thresholds, the type of operational mode is checked at step 812. The type of operational mode will be determined based on user preferences for the type and level or optimization and automation that is desired. Examples of the possibilities for these modes include, for example and without limitation, i) ATS Mode, in which power is supplied via a generator anytime grid power is unavailable, ii) Hybrid Mode, in which battery and solar power is used prior to starting a generator until a certain threshold for battery state of charge has been reached, iii) Delayed Mode, in which the system will delay for a set period of time following a power failure from the grid before starting a generator, or iv) Eco Mode, in which a full set of predictive parameters will be utilized in order to attempt to maximize the efficiency and reduce the emissions of the energy system overall, for example by maximize the self-consumption and minimizing the curtailment of a solar photovoltaic resource. Predictive parameters are generated based on historical trends in case of an optimized mode at step 814(a) or control action may be taken based solely upon saved operational thresholds and rules in case of the simple operational mode at step 814(a). The optimization algorithm can process real-time state, user preference/settings, as well as predictive parameters and can determine optimal actions in case of the optimized operational mode at step 816. Optimal control action is then taken automatically at step 818. In a state where the user commands or issues query at step 820, the control action is taken according to user command or data returned in response to query at step 822. The system state updates the cloud 824 for future events and user receives a system state update notification 826. Such update notifications may be in the form of a text message, electronic mail, or push notification that may be transmitted to a device operated by the user.

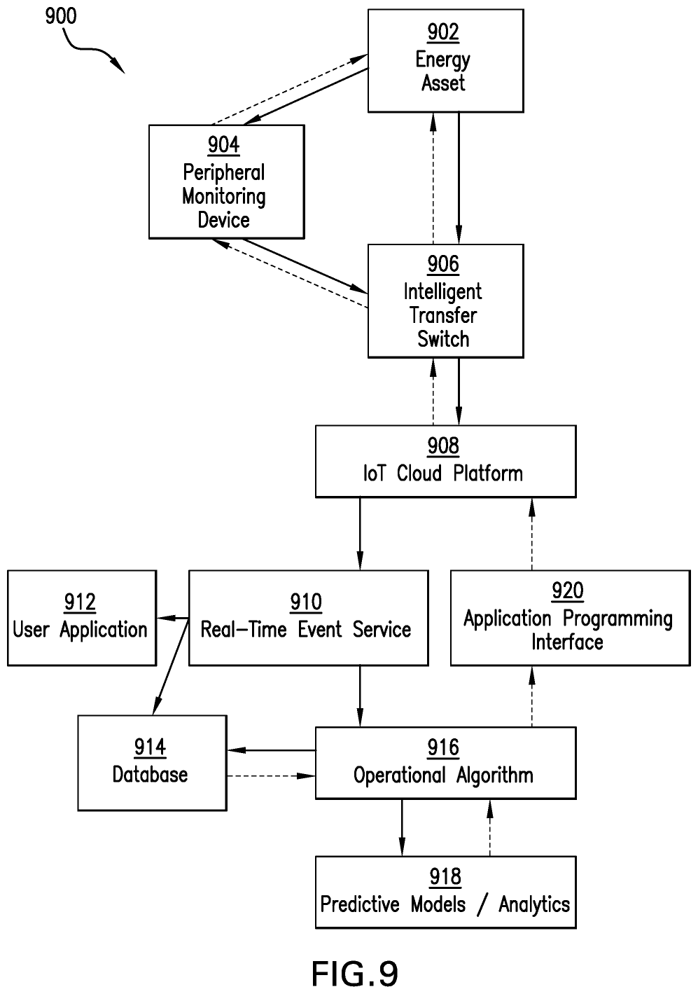

FIG. 9 describes more specifically the process 900 by which an event originating from the energy system in which an Intelligent Transfer Switch 906 is installed may initiate a decision-making process 800 that ultimately may lead to an operational action being taken based on automated processes. This figure further expands upon the general description provided in FIG. 8 by illustrating which systems and system components may be involved at each step in the automatic operational decision-making framework that is created through the integrated connectivity between the Intelligent Transfer Switch and the cloud software system. A system event may be created upon a discrete change in an energy asset's 902 state, for example and without limitation, the grid power source becoming available or unavailable, the generator source turning on or off, or the triggering or resolution of a system alarm. A system event may also be created as a continuous parameter value crosses a set threshold. Examples of such an instance may include solar production rising above a certain power level, battery state of charge dropping below a certain level, or consumption of power on the load output of the Intelligent Transfer Switch 906 crossing a threshold, indicating either high or low power usage. Upon the creation of a system event of either type described here, and originating either directly from the Intelligent Transfer Switch 906, or from a peripheral monitoring device 904 connected to the Intelligent Transfer Switch 906 via local network as previously described, the system event will be registered by the Intelligent Transfer Switch system 906. At this stage, the Intelligent Transfer Switch 906 may compare the event against a set of internal operation rules or thresholds. This local check, performed prior to any transmission to a broader network, may be a simple check against discrete rules such as whether a generator should be automatically started upon grid failure, or may include, in some embodiments, the utilization of predictive or otherwise analytical algorithms local to the device itself and performed in memory. This process may result in an immediate automatic action taken by the Intelligent Transfer Switch 906, or the process may also proceed with the transmission of the system event to the cloud, via initial communication to the IoT cloud platform 908.

The system event, having reached the cloud software system through initial receipt via the IoT cloud platform 908, will be transmitted to a real-time event service 910. This web service, in an embodiment, is responsible for the sorting, parsing and structured transmission of system events through the software cloud system, in and between what may be one or many web services which interact to form the full structure of the cloud software system 502. The real-time event service 910 may be made up, for example of a series of message brokers which utilize a queue mechanism to organize system events and indicate which services should respond to a given event. In an embodiment this will include, at least, transmission of the system event via message queues to a user application 912—where the event may be registered by an alert such as a push notification, SMS or email notification- to a database 914, where a record of the event will be stored such that it can later be accessed and analyzed; and to an operational algorithm service 916, which will process the incoming system event to determine if any automatic action should be taken in response to that event. This software service 916 will be responsible for determining, for example and in relation to the above described decision making process 800, if an automatic operation mode is enabled for the system in question and, if so, what type of operational mode is being utilized. If it is determined that yes, an automatic operational mode is enabled and that this mode includes, for example, an operational threshold around the prediction of an upcoming parameter value, the operation algorithm service 916 may query one or more databases 914 within the software system and utilize predictive models and particular analytics 918 to receive a value representing the likelihood of a future event occurring, or possible future value of a certain parameter, as estimated by the use of the predictive model 918 in conjunction with historical data. Having completed the process of receiving a predictive analytical value, the operation algorithm service 916 may compare this value to thresholds which have been established to indicate optimal operation of the system. In comparing the value to the threshold, the service will determine whether any and which control action should be taken upon the system via operation of the Intelligent Transfer Switch 906 or other controller peripheral monitoring devices 904. If so, the request for this action will be transmitted to the API 920 for further transmission to the IoT cloud platform 908 and ultimately directly to the Intelligent Transfer Switch 906, where the action will either be taken immediately by the Intelligent Transfer Switch 906 or be broadcast to a peripheral monitoring device 904 which may take the automatic action. With this process, real-time system events, as transmitted by the Intelligent Transfer Switch 906, can be processed by cloud software services 502, employing advanced analytics and modeling to inform the optimal operational actions of the Intelligent Transfer Switch and supplement any internal decision making that is local to the physical unit. The integration of these two decision making process affords a level of dynamic control and flexibility that allows the Intelligent Transfer Switch to function optimally across a variety of changing conditions, and even as preferred operation modes change according to the desired optimization parameter or parameters.

### Enabling Examples of Operational Decision-Making Scenarios

The following scenarios illustrate and concretize a sampling of the operation decisions and processes described above by defining certain exemplary conditions and events and indicating specifically how the system may respond and act under these conditions.

In the first enabling example scenario we consider a system as described by FIG.1 which is currently supplying power to the load from the utility grid source. While operating in this state, the utility grid source becomes unavailable, disconnecting power from the load. The Intelligent Transfer Switch determines from its internal memory that it should be running in “ATS Mode”, in which the generator should be turned on immediately upon the occurrence of a grid outage. Accordingly, the generator is started using the remote start signal and the load is switched onto the generator after an engine warm up period. The system then continues to power the load from the generator until the grid power becomes available once again. Upon sensing this event, the Intelligent Transfer Switch returns the load to the grid power source and, following this switch and an engine cool down period, turns the generator off by removing the remote start signal.

In a second enabling example scenario we again consider a system as described by FIG. 1 which is currently supplying power to the load from the utility grid source. In this scenario, the utility grid source once again because unavailable, disconnecting power from the load. The Intelligent Transfer Switch determines in this case that it is set to “Delayed Mode” and initiates a communication process with the cloud to determine the length of delay which should be imposed after grid failure before initiating a transfer to the generator set. In this scenario, the cloud software system responds to the request by indicating that a period of two hours delay is preferred according to the automatic operational mode which has been set for the device currently. The specific delay period enacted may have been set by the user through the use of a user interface such as a mobile application or web application, or it may have been set automatically by the system based on analytics previously performed on this energy system which dictated that a two hour delay is optimal based on, for example, typical patterns of energy consumption and how they may relate to factors such as battery bank state of charge, temperature within a building, or others. Accordingly, the Intelligent Transfer Switch begins a timer of two hours at the end of which it will run the generator if the grid power supply has not yet become available again. In this scenario, after one hour, the user may determine that they need to increase their power capacity prior to the elapsing of the two-hour delay window. From a mobile application interface, the user requests an immediate switch to the generator. This request, as transmitted via the API and IoT Cloud Platform to the Intelligent Transfer Switch, overrides the current automatic operational mode, and initiates an immediate switch to the generator despite the fact that the two hour period has not completed. As in the previous example, the generator is started via remote start signal and the load is switched onto the generator after the engine warm up period.

In a third enabling example scenario we consider a system as described in FIG. 1, in which peripheral monitoring devices have been installed and configured to provide monitoring and control functionality with the hybrid inverter system, including both the solar photovoltaic array and the battery storage bank. In this scenario, the system is currently configured so that the utility grid supply is being used to power the loads of the building, and is also recharging the battery bank through the hybrid inverter system. After a period of time has elapsed, the battery bank reaches a full level of charge, and a system event is generated to mark that the battery charging cycle has completed. This event is first generated by the peripheral monitoring device which has been configured to track the battery bank's state of charge. It is communicated via wireless communication protocol to the Intelligent Transfer Switch, which, in receiving this event and determining that the current operational mode of the system is “Eco Mode”—in which operations should be carried out such that they optimize for reduced emissions and maximal solar self-consumption—transmits this event to the cloud software system for further processing and to determine if further control actions on the system are warranted. Within the cloud software system, the event information is stored in a database and also fed into the operational algorithm. In this example scenario, the operational algorithm performs a predictive analysis on two key parameters, expected energy consumption in the building over an upcoming period of time, and expected solar energy production over an upcoming period of time. This period of time may vary according to the exact scenario. For the sake of clarity in this example scenario, we will consider that the system has initiated this process at 8:00 am on a given day, and is considering an upcoming period of 7 hours, but it will be appreciated that this process may be initiated at any time of day and consider varying predictive periods while maintaining the spirit of the disclosed inventive concepts. Utilizing a predictive analysis based upon the historical energy consumption data collected from this site, as well as weather forecast analysis data for the geographical location in which the site is located, the operational algorithm determines that the expected solar yield over the course of the period is 10 kWh of production between the hours of 11:00 am and 3:00 pm. The operational algorithm further determines that the expected energy consumption will be 8 kWh between the hours of 8:00 am and 11:00 am and 4 kWh between the hours of 11:00 am and 3:00 pm. Based upon these predictive figures, it is determined that there is a very high likelihood that solar energy will be wasted, as the predicted consumption value is 6 kWh lower than the predicted production during the same period. Therefore, in order to maximize the self consumption of the solar resource, the operational algorithm generates a resulting action to disconnect from the utility grid power source. Consequently, between the period of 8:00 am to 11:00 am, energy is utilized from the battery storage bank, depleting its charged capacity by 8 kWh. Following this, between the period of 11:00 am to 3:00 pm, 10 kWh of solar energy are produced and 4 kWh of energy are further consumed by the loads. Due to the preceding depletion of the battery capacity, the 6 kWh excess generated by the solar photovoltaic array is thus stored within the battery bank, while also meeting the load demand. By the end of this period, the battery storage system has net discharged 2 kWh, and the solar array was not forced to curtail its production at any point. This type of optimization in operational decision making may make use of many factors, including but not limited to the energy consumption and solar production estimations described here. This example scenario illustrates a way in which the integrated system, being triggered by real-time events originating from the state or value of energy assets or energy parameters respectively, may make use of current data, historical trends, and predictive estimates or forecast to arrive at the optimal operational decision for the maximization of solar self-consumption. It further illustrates, in conjunction with previous enabling examples, the manner by which this maximization goal is flexibly and dynamically established through the setting of various “Modes” which dictate the processes and system components involved in operational decision-making.

In a fourth enabling example scenario, we again consider a system as described in FIG. 1 with peripheral monitoring devices configured as in the previous example scenario. In this scenario, the system is operating with no power from either the utility supply or the generator. The battery storage bank has been supplying power to the load for some period of time, and is depleted to, for example, 60% state of charge. At this time, the user, from a user interface such as a mobile application or web application, initiates a request to start the generator in order to supply power to the larger loads in the building which are not powered by the hybrid inverter back-up system. This request, processed initially by the application programming interface, is transmitted to the Intelligent Transfer Switch immediately and the generator is started via the remote start interface. Simultaneously, the new event corresponding to the requested change of power to the generator is transmitted within the cloud software system to the real-time event processing service and correspondingly the operational algorithm. In this scenario, the user preferences dictate that the most important optimization parameter is cost, and operational decisions should be enacted based on the lowest cost option. Given that solar production from already installed solar photovoltaic assets produces no marginal cost through, for example, fuel use or the need to purchase credits for utility grid power, solar production is the lowest cost resource within an energy system. Accordingly, the operational algorithm will determine if solar power can be used to charge the available capacity within the battery bank. In this scenario it is determined that no solar production will occur within an acceptable window for recharging the battery storage bank. The operational algorithm will then perform a predictive analysis of utility grid availability, since power supplied from the utility grid is significantly lower cost than power supplied from the generator source. The result of predictive analysis, based on historical trends for grid availability at this building and near-by properties, indicates there is a very high likelihood that the utility power will be restored within an acceptable window for battery charging. It is therefore determined that the generator source should not be utilized to charge the battery bank. The operational algorithm initiates a control command to the Intelligent Transfer Switch, which further transmits that command to the peripheral monitoring device configured to control the hybrid inverter charging modes, and the charging of the battery is correspondingly temporarily disabled. After some time, the utility grid power is restored. Immediately, the load is transferred to the grid power source, and the generator set is turned off by removing the remote start signal. The Intelligent Transfer Switch transmits these events to the cloud software system, which, in incorporating the recent changes within the operational algorithm, issues a command to re-initiate battery charging now that the utility grid source, a lower cost power supply, has been established. This command is once again transmitted to the peripheral monitoring device via the Intelligent Transfer Switch, and the battery bank is re-charged over the next period of time as the utility grid power is used. In this example, the Intelligent Transfer Switch system demonstrates the ability to utilize tiered decision making logic to remain flexible and intelligent in automatic operation of an energy system. A switch to generator power is performed based on immediate user preferences, but underlying operation logic and predictive analysis is still utilized to optimize cost outcomes to the maximum extent possible given the conditions at the time of the user action.

Inventive concepts disclosed herein are directed to a system for supplying power to a load output from a plurality of power source inputs, comprising in an embodiment: a memory having computer readable instructions stored thereon; and at least one processor configured to execute the computer readable instructions to collect data from a plurality of sources, the data corresponding to energy consumption, utility grid availability, and solar energy production, for example and without limitation; build a model based on the data collected from the plurality of sources; and test a set of operational rules and strategies for running the system based on the data collected.

Inventive concepts disclosed herein are directed to an apparatus for supplying power to a load output from a plurality of power source inputs, comprising in an embodiment: at least two inputs including a first input and a second input, the first input typically but not exclusively corresponding to a grid supply and the second input typically but not exclusively corresponding to a generator supply; a first power switching component and a second power switching component protectively interlocked from the first power switching component, wherein, the first input is coupled to the first power switching component and the second input is coupled to the second power switching component.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

The present inventive concepts claim a device comprised of the power switching sub-system, which may function primarily through the actuation of an assembled pair of mechanically interlocked contactors, with electromechanical coils powered through relays driven by digital logic. The logic is dictated through the controls system according to switching commands generated automatically, through user action within a digital interface, or through user activation of a pushbutton switch on the physical device. The combination of these various inputs in determining the operation of the switch allows the present inventive concepts to achieve a novel level of flexibility and dynamic decision making for power switching systems. The power system further includes a means for manual fallback operation, in which power from the incoming energy sources is used to directly engage contactor coils by means of a manually operated selector switch or switches that simultaneously disable the controls sub-system from acting upon the power switching mechanism while this manual mode is utilized.

The present inventive concepts claim a device comprised of the energy metering sub-system to allow complete monitoring and metering of energy provided to the load outputs of the switch including current measurement and voltage measurement of up to three active phases, with the capability of metering both forward and reverse energy flows, and power quality indicators such as power factor, voltage, frequency, and phase balance, among others. For example as configured in a three phase wye power supply, each phase corresponds to a voltage signal offset 120 degrees from the others relative to the neutral conductor.

The present inventive concepts claim a device comprised of the controls and communication sub-system incorporating an integrated and dedicated network connectivity device, for example a cellular network module, and a wired or wireless local area network module for communication, allowing information to be exchanged with the internet/cloud directly as well as other peripheral devices on a local network. Information exchange through the cellular module to the software cloud infrastructure allows integration of hardware and software layers to create a complete management platform, in which decision making around the operation of the power switching system may be informed by external datasets and the output commands of specialized algorithms incorporating, for example, model based optimization parameters or predictive analytics based on historical data trends.

The present inventive concepts claim a device comprising a dedicated and integrated connection to the internet. The present inventive concepts ensure that operational logic is not constrained by information accessible only within the context of the single device and user commands/settings/preferences may be accessed and updated remotely, as described in conjunction with the description of FIG. 7. Furthermore the information is assessed to determine optimal operational strategies at any given moment. In order to realize the benefits of real-time remote access to the switching device, the full embodiment of the inventive concepts may include cloud software infrastructure to provide a remote interface for users to interact with the switching system.

The present inventive concepts further claim a device comprising an integrated power-switching subsystem, energy metering sub-system, and controls and communication sub-system—the three subsystems as described herein. Further, the present inventive concepts may also claim a dedicated and integrated connection to a network, such as the internet, and cloud software infrastructure intentionally designed to support the collection of key data and real-time, optimized operation of the connected Intelligent Transfer Switch unit, as described herein.

In an embodiment of the inventive concept, the system processor utilizes a specialized algorithm for operating the switching device with corresponding benefits. The system may record historical data and monitor power supply events, and thus allow the algorithm to determine optimal operating strategies for the system based on optimization of one or more target parameters, including but not limited to, system efficiency, cost, emissions, or power quality. For example and without limitation, if the processor's algorithm recognizes a reduced power supply or power outage to occur in a certain amount of time in the future based on historical data or current power supply events, the system will ensure the generator, battery bank, or other alternative power supply will be available and operational at the necessary time. In another non-limiting example case, the specialized algorithm will utilize historical data to create predictive parameters for solar production and energy consumption to determine that an oversupply of solar production is likely during the upcoming hours. In this event the system will prioritize use of energy stored in a battery bank leading up to this event in order to create empty battery capacity in which to store the predicted solar overproduction. In a third non-limiting example, the algorithm will assess historical energy consumption trends as well as user set preferences to determine that the system may soon require increased power capacity, and will start a connected generator if other energy sources can not meet this increased capacity, thereby ensuring the user's power availability is not constrained.

It will be recognized that while certain aspects of the disclosure are described in terms of a specific sequence of steps of a method, these descriptions are only illustrative of the broader methods of the disclosure and may be modified as required by the application. Certain steps may be rendered unnecessary or optional under certain circumstances. Additionally, certain steps or functionality may be added to the disclosed implementations, or the order of performance of two or more steps permuted. All such variations are encompassed within the disclosure disclosed and claimed herein. The disclosure references the “internet”, but it will be appreciated that any network may be used without departing from the details of the disclosure.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated for carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art of practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least”; the term “such as” should be interpreted as “such as, without limitation”; the term ‘includes” should be interpreted as “includes but is not limited to”; the term “example” is used to provide exemplary instances of the item in discussion, not an exhaustive or limiting list thereof, and should be interpreted as “example, but without limitation”; adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A system for supplying power to a load output from a plurality of power source inputs, comprising:
a power switching sub-system; and
a control and communication sub-system.

2. The system of claim 1, wherein the control and communication sub-system is configured with:
an integrated and dedicated connection to a network;
a memory capable of storing computer readable instructions thereon; and
at least one processor configured to execute the computer readable instructions.

3. The system of claim 2, further comprising:
a cloud software system, established or adapted to communicate with a physical system comprising the power switching sub-system.

4. The system of claim 3, wherein the processor configured to execute the computer readable instructions:
collects, stores and updates data from a plurality of sources, the data corresponding to at least one of: the state of the switching system, characteristics of the power supply, other control parameters for the system, or other available datasets;
transmits the data to the cloud software system;
receives commands from the cloud software system; and
actuates physical changes within the system based on the received commands.

5. The system of claim 3, further comprising:
an integrated and dedicated connection to a network, wherein the connection is utilized to receive data from and send commands to other devices on the network for the purpose of collecting more data and extending the control capabilities of the system to other physical systems outside of the power switching sub-system.

6. The system of claim 2, further comprising:
an energy metering sub-subsystem, configured to provide energy metering capabilities on the load output.

7. The system of claim 3, wherein the communication between the physical system comprising the power-switching sub-system and the cloud software system enables:
building of a software model of the power supply system;
utilizing the software model to set operational thresholds for decision making around control actions to perform on the power supply system;
processing of real-time system events by an operational algorithm to determine optimal control actions to perform on the power-supply system.

8. The system of claim 7, wherein the cloud software system further enables
providing a user interface to allow viewing of transmitted data;
providing real-time alerts to the users via at least one of a text message, electronic mail, or push notification;
allowing remote command signals to be sent by the user to the power-switching sub-system to initiate control actions within the power supply system, at times overriding the control actions taken based upon the operational algorithm.

9. A method of determining an operational action in a power-supply system comprising:
Registering a system event in the power-supply system;
Comparing the event to a set of internal operational rules;
Transmitting the event to an IoT cloud platform and to a real-time event service;
Transmitting the event to an algorithm service to determine if automatic action should be taken in response to the event;
Receiving prediction analytics on at least one of the likelihood of a future event occurring and the future value of a power-supply system parameter;
Comparing a predictive analytics value to an established threshold of optimal operation of the energy system; and
Determining whether control action should be taken on the energy system based on comparison of predictive analytics value to operational thresholds.

10. A system for supplying power to a load output from a plurality of power source inputs, comprising:
a memory having computer readable instructions stored thereon;
at least one processor configured to execute the computer readable instructions to:
collect data from a plurality of sources, the data corresponding to energy consumption, utility grid availability, and solar energy production;
build a model based on the data collected from the plurality of sources; and
test a set of operational rules and strategies for running the system based on the data collected.

11. The system of claim 10, wherein the at least one processor is further configured to execute the computer readable instructions to:
identify a threshold for utilizing at least one of a plurality of resources; and
determine use of the plurality of resources based on optimization of at least one target parameter.

12. The system of claim 10, wherein the at least one processor is further configured to execute the computer readable instructions to:
store the collected data in the memory, and
update the memory with the collected data based on additional data collected from the plurality of sources.

13. The system of claim 10, wherein the at least one processor is further configured to execute the computer readable instructions to:
transmit information to a hand-held device operated by a user, the information being transmitted by at least one of a text message, electronic mail, and push notification.

14. An apparatus for supplying power to a load output and capable of switching between a plurality of power source inputs comprising:
an integrated power-switching subsystem, energy metering sub-system, and controls and communication sub-system.

15. The apparatus of claim 14 further comprising:
a network connection; and
cloud software infrastructure including at least one memory and at least one processor, the memory including computer readable instructions stored thereon, and the at least one processor configured to execute the computer readable instructions to perform a specialized algorithm in the cloud software architecture,
wherein the network connection is configured to connect the cloud software infrastructure with at least one of the integrated power-switching subsystem, the energy metering sub-system, and the controls and communication sub-system.

16. The method of claim 9 further comprising:
determining which control action should be taken on the energy system based on comparison of predictive analytics value to operational thresholds; and
performing the operational action.

17. The system of claim 7 further enabling sending of remote command signals from the cloud software system to the physical system in order to trigger the execution of the determined optimal control actions.

18. A method of supplying power to a load output from a plurality of power source inputs, the method comprising:
collecting data relating to the plurality of power source inputs;
testing operational rules and strategies for running the power system;
identifying optimal thresholds for utilizing power supply resources;
checking operational mode of the system;
receiving real-time events corresponding to changes in the system state;
determining whether an operational action should be taken on the system in real time; and
performing an operational control action on the system.

19. A nontransitory computer readable medium storing a set of instructions for supplying power to a load output from a plurality of power source inputs, the set of instructions comprising instructions which when executed by a processor of the computing device, cause the processor to:
collect data relating to the plurality of power source inputs;
test operational rules and strategies for running the power system;
identify optimal thresholds for utilizing power supply resources;
check operational mode of the system;
receive real-time events corresponding to changes in the system state;
determine whether an operational action should be taken on the system in real time; and
perform an operational control action on the system.
